(19) United States
(12) Patent Application Publication
(10) Pub. No.: US 2008/0204266 A1
(43) Pub. Date: Aug. 28, 2008

(54) Method and Device For Implementing Vibration Output Commands in Mobile Terminal Devices

(76) Inventors: Jussi Malmberg, Turku (FI); Jyri P. Salomaa, Jorvas (IT)

Correspondence Address: Hollingsworth & Funk, 8009 34th Avenue South, Suite 125, Minneapolis, MN, 55425, US

(21) Appl. No.: 10/588,180

(22) PCT Filed: Feb. 3, 2004
(86) PCT No.: PCT/IB04/00260

§ 371 Date: Mar. 9, 2007

(51) Int. Cl. G08B 21/00; H04M 3/00

(52) U.S. Cl. 340/683; 455/418

(57) ABSTRACT

The present invention relates to method implementing vibration output commands for controlling a vibration actuator of a mobile terminal device and mobile terminal devices to execute this method. The method is based on defining at least one vibration effect, defined by at least one vibration signal parameter, defining at least one vibration pattern by at least one of said vibration effects, and storing said at least one vibration pattern into a storage.

The present invention relates to mobile terminal devices that are enabled to use a vibration alarm. It also relates to mobile electronic terminal devices that are enabled for executing game software. More specifically, the invention relates to a simple method to implement a vibration as a haptic output for game implementations of mobile terminal devices.

Presently, there are different kinds of force feedback implementations available, such as e.g. defined in the US Documents U.S. Pat. No. 6,285,351, U.S. Pat. No. 6,169,540 and U.S. Pat. No. 6,147,674. The force feedback implementations are designed to simulate the operating forces of a real operation element or input device. The force feedback output is performed by an application and is directly correlated to the position of an input device, such as it is known from non mobile gaming devices imitating e.g. the forces for operating a steering wheel in a race simulation game.

The document WO 02/27705 A1 “Directional tactile feedback for haptic feedback interface devices” discloses a closer state of the art, as this document is based on an haptic output accompanying that is not directly tied to an actual position or displacement of an input element. This document is related to a technology to combine two vibration actuators to provide different haptic sensations to a user of an input element.

All the above approaches for a force feedback or haptic vibration output have in common that they are not suitable for the use with mobile terminal devices as mobile phones, or handheld computers. This is due to low storage space for storing said vibration data, low computing power for generating an additional vibration output, or a low battery capacity for repeatedly operating a power consuming vibration actuator.

It is further desirable to provide a simple solution use the vibration alarm actuator of a mobile telephone also for other applications such as game applications running on a telephone. It is desirable to further develop the capabilities of present mobile devices to further utilize the resources offered by mobile devices.

It is further desirable to reduce the programming expense and the storage requirements for implementing a vibration output.

According to a first aspect of the present invention a method for implementing vibration output commands for controlling a vibration actuator of a mobile terminal device is provided. The method comprises defining at least one vibration effect, defining at least one vibration pattern comprising defined vibration effect and storing said vibration pattern.

In a basic version a vibration effect may e.g. be defined by an intensity and a length or duration. It is also possible to use a default intensity and a default duration.

The vibration patterns are at least defined by said vibration effects. A vibration pattern may be regarded as a kind of container to simplify the access to a sequence of vibration effects. A vibration pattern may even comprise no vibration effects, but such a pattern would induce no vibration when executed. The vibration patterns can be defined by composing or arranging said vibration effects in a succession of a sequence, and naming this sequence.

By storing said at least one vibration pattern into a storage said vibration patterns are made available in a retrievable form. Thus the vibration patterns can be retrieved to control e.g. a vibration actuator of a device. The vibration patterns and the vibration effects can be stored for example as extensible markup language coded data into said storage.

It may to be noted that invention is primarily directed to a vibration output and not primarily to force feedback. The vibration output can be performed by an application and may not be directly correlated to the position of an input device.

A pattern itself does not produce any vibration. A small fraction of pattern called effect is responsible for one vibration component. An effect is specified i.e. one vibration component is defined in a basic version by two parameters. These parameters are time and intensity. The time is indicative of how long the one vibration component will continuously last.

As shortest possible time interval microseconds, i.e. 10 e-6 seconds can be selected. The range of the time parameter is from 0 to theoretically infinity. Actually the time parameter for a vibration is an integer value with a minimum value of 1 micro second (μs) and a maximum value of e.g. 86,400,000,000 μs (=one day). In this framework a second of vibration would be caused by a time equal to 1000000. A zero-time value of the vibration effect may be useful when developing vibration patterns, but a vibration effect with a zero-duration actually does not effect any vibration. Other time scales are also possible.

The intensity tells how powerful the vibration is to be. The intensity can range for example from 0 to 100. Intensity can be defined as a percentage, wherein 100% represents the maximum vibration power and 0% the minimum vibration power (no vibration). In contrast to the zero-time duration a 0% intensity means that during the vibration effect there will be no vibration (i.e. a pause). It is also possible to implement the intensity as values ranging from 0 to 124 which may better fit to the binary nature of modern electronic devices.

It is also possible to adapt the time and intensity division to vibration and time sensing capabilities of human beings. It is also possible to add thresholds to avoid unnoticeable haptic events or signal loss caused by a reaction delay of said vibration actuator or a time threshold for starting said vibration actuator.

It may also be possible to implement a negative i.e. “0% to −100%” percent vibration, i.e. a vibration actuator running backwards. These ranges may also be combined to a ±100% range. This can be useful to generate hard impulse vibrations, e.g. to stop a vibration motor with a backward impulse.

The present invention is related to the programming and generating and reproducing of haptic effects, especially by the use of a vibration actuator of mobile terminals. Thereby, the present invention allows to use provide e.g. in a game application to provide a user with vibration effects additional to display content and sounds.

The programming expense for implementing a vibration output on a device is relatively high. If several different vibration effects are to be used in one or more applications, the storage requirements and the programming expense increase.

In another embodiment of the present invention said vibration signal parameter includes at least one of a designation (name), an intensity, and a duration of a vibration.

The vibration effects are at least defined by at least one vibration signal parameter a designation, intensity, and duration of a vibration. Thus in a basic version a vibration effect may e.g. be defined by an intensity and a length or duration. That is, in this embodiment the length of the vibration pattern is definite, and the intensity (or amplitude) within the duration of the vibration is constant and definite. In this basic version of the invention the frequency of the vibration is not selectable. The designation or the name of a vibration effect is freely selectable.

The effects can also have a designation or name. This is defined as the third and last parameter of a vibration effect. Two individual effects may have a same name (even if the intensities and the duration may differ). Actually, it is recommended to name the equivalent effects with the same name.

The vibration effects may also be defined by other parameters such as e.g. a gradient of an intensity change, a frequency of gradient of a frequency change.

In another embodiment of the present invention said at least one vibration pattern is also defined by a designation of the vibration pattern. When combining different effects together, they form an entity called pattern. The patterns have at least one additional parameter: the pattern designation or name.

The name separates a pattern from others. The vibration patterns can be defined by composing or arranging said vibration effects in a succession of a sequence, and naming this sequence. The designation of the effects and patterns can be used to implement names of the effects and patterns. In a basic version a developer or programmer of a vibration pattern (and its effects) has no indication which pattern he is actually working on. By naming the patterns and the effects a developer of a vibration pattern can easily select a descriptive name for the pattern and for the effects he is working on. Thus a programmer may name a pattern “start engine”, and the effects “start engine, part 7”. The programmer can easily arrange or compose a vibration effect pattern out of said single vibration effects.

The designation is an informative parameter. However the designation is a practical feature when creating patterns with different effects with e.g. an XML editor and playing them with XMLVibraPlayer. The designating can be used to separate different vibration units or items.

In another embodiment of the present invention said vibration patterns are further defined by a frequency and or a phase of said vibration. In another embodiment of the present invention said vibration effects are further defined by a frequency and or a phase of said vibration. By using a frequency and a phase information for a vibration, the present invention can also be applied to vibration actuators that can be operated with different vibration frequencies. In the future there may be a vibration actuator implementation capable of a kind of “polyphone call vibration signaling” capability.

In yet another example embodiment of the present invention the method further comprises retrieving and sending a stored vibration pattern to a mobile k least one stored vibration pattern and sending said at least one vibration pattern to a terminal device a designed or generated vibration pattern can be made available for test or application purposes. A programmer or vibration pattern designer can transfer a generated pattern to a mobile terminal device to test the haptic sensation of a vibration effect or a vibration pattern, on specific telephone models.

In another example embodiment said method further comprises selecting at least one of said stored vibration patterns. Thereby a online gaming server side application can assess different vibration patterns for different connected mobile devices, and provide simple terminals with a vibration output, even if said terminals have not been designed for game related vibration output.

In an example embodiment, said method further comprises receiving vibration data, and defining said vibration effects and said vibration patterns according to said vibration data. By receiving vibration data, for example data from an external sensor can be used to automatically generate said vibration effects and patterns. Thereby the possibility is provided to “record” vibration patterns and automatically generate a respective vibration output in form of vibration patterns and vibration effects. That is e.g. data received from an acceleration sensor or a position sensor, fixed to a vibrating device can be used record a natural vibration.

By defining said vibration effects and said at least one vibration pattern according to said vibration data, the programming expense can drastically be reduced for generating the vibration patterns.

This embodiment also allows an automated “translation” of vibration patterns to different mobile devices as these devices can have different intrinsic vibration frequencies, different or different inertia relations of vibrating mass and mass of the terminal devices. This part of the present invention enables the developer to build up and use a vibration database, or a vibration library for generating vibration patterns.

The embodiments described in the preceding specification are directed to generate and send vibration patterns. These embodiments can be used to provide a data stream of a game server with additional vibration commands that can be added to increase the game experience of a user.

According to another aspect of the present invention, a method for implementing vibration output commands for controlling a vibration actuator of a mobile terminal device is provided. The method comprises, receiving at least one vibration pattern, and storing said least one vibration pattern. Each of said vibration patterns is defined by a succession of vibration effects, and each vibration effect is defined by at least one vibration signal parameter.

By performing this method a user can simply receive or load a number of vibration patterns for a future use. The vibration patterns may be received within the context of loading game software for use during the execution of a game. The vibration patterns may be received within the context of loading vibration patterns for silent message/call signaling.

In yet another example embodiment said method, further comprises: receiving a request for a vibration pattern, retrieving it and sequentially outputting each vibration effect of said pattern, by controlling a vibration actuator accordingly.

By receiving a request for a vibration pattern to be output, a running program can demand the reproduction of a vibration pattern, e.g. via an application program interface. The retrieving of said requested vibration pattern is then reproduced by sequentially outputting or replaying each vibration effect. The vibration effect and thus the vibration pattern is replayed by controlling a vibration actuator according to the intensity and duration values stored in said vibration effects.

The above embodiments are directed to transfer a number of vibration patterns to a mobile device, for a later use.

According to yet another aspect of the invention, a method for operating a vibration actuator of a mobile terminal device is provided. The method comprises receiving at least one vibration pattern, and outputting said vibration pattern. The vibration patterns are of the type already disclosed in the preceding specification each of said comprising at least one vibration effect. The vibration effects are defined each by at least one vibration signal parameter.

The vibration pattern is reproduced by sequentially outputting each of said at least one vibration effect of said received vibration pattern, by controlling a vibration actuator according to the intensity and the duration defined in each of said vibration effects.

That is, a vibration pattern is received and is immediately reproduced or outputted. This feature can be used in online games running on a centralized game server. Thereby, a vibration data stream can be provided additionally to a game data stream to increase the experience of a user.

The above embodiments are directed to receive vibration patterns and generating a respective vibration on a mobile terminal device, immediately. This can be used for providing the vibration patterns in a data stream e.g. in the case of online gaming.

In another embodiment of the present invention said vibration signal parameter includes at least one of a designation, an intensity, and a duration of a vibration, as defined and disclosed in the preceding specification.

In yet another embodiment of the present invention said at least one vibration pattern is also defined by a designation of the vibration pattern as defined and disclosed in the preceding specification.

In another example embodiment of the present invention said vibration intensity of said vibration effects is defined by a duty cycle. This can control an intensity of a vibration, even if the vibration actuator or the device is only capable to be operated with a single intensity. The duty cycle represents a pulse width modulation. The pulse width modulation is operated at an arbitrary but fixed frequency. The period of a modulation can be shorter than the smallest selectable vibration period. The period of a modulation can also comprise e.g. more than one (e.g. ten of the) smallest selectable vibration duration.

In current mobile terminal devices the vibration motor vibrating (or rotating) frequency is fixed into some value for example to 256 Hz depending on what kind of vibration motor actually has been integrated into the device. Thus, this frequency value can not be changed from the software side. Additionally, the voltage supply for the vibration motor is usually provided with a fixed value.

However, the Pulse Width Modulation (PWM) of the duty cycle percentage (0-100%) could be changed. That is, even in systems that are designed to operate the vibration actuator only with a single operating voltage, a second parameter (i.e. the intensity) defined in a vibration effect (beside the duration). The PWM duty cycle defines the time how long power (voltage) is feed for to the vibration motor within a certain time frame. The time frame defines a PWM frequency i.e. by the length of the time period between the beginning of two power supply pulses for the vibration motor. The PWM period may e.g. be one hundredth μs. i.e. in case of a 100% control the lowest vibration intensity (1%) represents a pulse width of 0.01 μs, followed by a pause of 0.99 μs. The bigger the percentage is the faster the vibration motor starts spinning.

In another example embodiment of the present invention said vibration patterns and vibration effects are generated, stored, and sent as extensible markup language (XML) coded data. By using XML data, a clear and simple and universal programming language is selected to implement the reproduction of vibration patterns in applications and devices that have initially not been planned to be used for this purpose.

This enables developers of applications e.g. game developers to use XML for example in a Software Development Kit as a tool for creating vibration patterns to create and implement vibration effects for their applications e.g. games.

The invention provides this through some service applications in the operation system, of the mobile terminal. A well-defined XML document loaded from outside into the phone can control the vibration of a vibration actuator with patterns of vibrations. Any available XML editor application is suitable for creating these XML files.

The method disclosed in the preceding specification can also be combined to a system method directed to generate or recall a vibration pattern at a server and transfer these patterns to a mobile terminal device for immediate execution.

It is also possible to combine a system method directed to recall a vibration pattern at a server and transfer the pattern to a mobile terminal device for later execution e.g. by an application program running on said terminal.

According to yet another aspect of the invention, a software tool is provided comprising program code means for carrying out the method of the preceding description when said program product is run on a computer, a mobile terminal device, or a network device. According to yet another aspect of the invention, a computer program product is provided comprising program code means stored on a computer readable medium for carrying out the methods of the preceding description, when said program product is run on a computer, a mobile terminal device, or a network device.

According to another aspect of the present invention, a mobile device is provided that comprises a processing unit, an interface, and a vibration actuator. Said interface and said vibration actuator are each connected to said processing unit. Said terminal device is configured to receive at least one vibration pattern via said radio interface. Said at least one received vibration pattern comprises at least one vibration effect, and each of said vibration effects comprises at least one vibration signal parameter. Said CPU is further configured to sequentially control said vibration actuator according to said intensity and said duration of said at least one vibration effect.

In another embodiment of the present invention said vibration signal parameter includes at least one of a designation, an intensity, and a duration of a vibration, as defined and disclosed in the preceding specification related to the description of the method of the present invention.

In yet another embodiment of the present invention said at least one vibration pattern is also defined by a designation of the vibration pattern as defined and disclosed in the preceding description of the method of the present invention.

In an example embodiment said vibration patterns and the vibration effects said patterns are composed of are received in form of extended markup language (XML) files. The XML files are received via said interface. Said interface can be a radio interface, a network interface, or a slot for receiving external memory cards (such as for example compact flash, multimedia card MMC).

In yet another embodiment of the present invention, said mobile terminal further comprises a storage to store said received vibration patterns. By storing said patterns these patterns are made accessible for the terminal or for applications running on said terminal.

In another example embodiment of the present invention said processing unit is configured to execute an application program capable of accessing stored vibration patterns. That is, the vibration patterns, (or the XML files comprising said patterns) are made accessible by a program application running on said CPU. Thereby, an Application Program interface (API) for commanding the vibration motor in the mobile device can be defined through an XML file.

In another example embodiment of the present invention said interface, is a radio interface. Such as e.g. a Bluetooth-, W-LAN-, of mobile telephone (such as GSM, GPRS, or UMTS) interfaces.

In yet another example embodiment of the present invention said mobile device comprises a subscriber terminal in a telecommunication system such as e.g. a mobile telephone. The XML based vibration output can also be implemented in devices such as mobile phones, communicators, palmtops, PDAs, handheld GPS devices, portable game consoles or combinations thereof.

This enables a developer to implement vibration effects even on mobile terminals that are initially not intended to use a vibration actuator for other applications than silent call/message signaling. In game applications this vibration actuator may also be used for outputting haptic signals to imitate the start up movements of a car in a race game application, recoils, or collisions. A user or a player can be provided with a more complete simulation by exiting also the sense of touch of a user.

In the following, the invention will be described in detail by referring to the enclosed drawings in which:

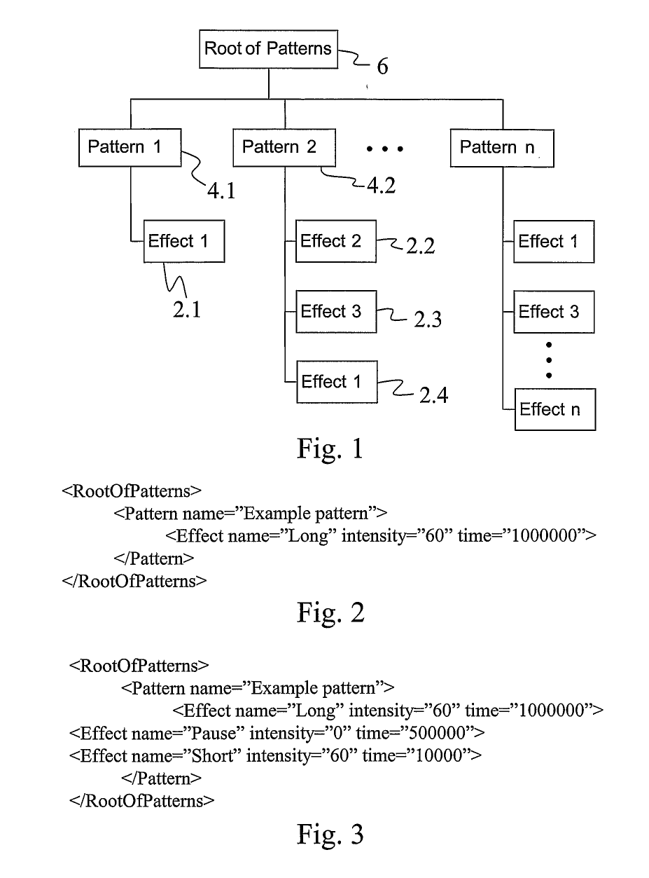

FIG. 1 visualizes a pattern hierarchy according to one embodiment of the present invention, The FIGS. 2 to 5 show different examples of vibration patterns in XML code,

FIG. 6 represents an implementation of a program architecture in a mobile terminal device,

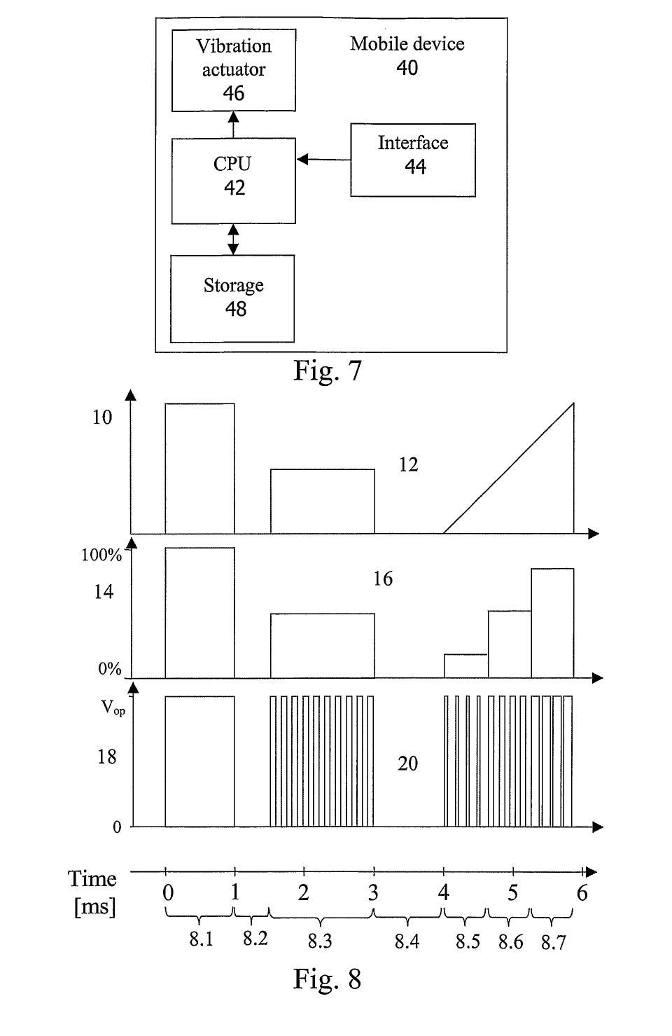

FIG. 7 is a simplified block diagram illustrating an example of the structure of a portable device, and

FIG. 8 illustrates an exemplary signaling pattern in three diagrams where the x-axis represents time and the y-axes represents intensities.

FIG. 1 visualizes a pattern hierarchy according to one embodiment of the present invention. It is to be noted that a pattern itself does not produce a vibration. A small fraction or constituent of a pattern i.e. a vibration effect represents one element of component of vibration. A vibration effect is determined by two parameters. These parameters are time and intensity. The time of the vibration effect represents the duration i.e. the length of a vibration.

The intensity tells that how powerful the vibration will be generated. The effects are also provided with a designation or a name. In the figures this is defined as the third and last parameter. Two individual effects may have the same name. Equivalent effects can e provided with the same designation.

A pattern represents a kind of a vibration effect container, wherein in a vibration pattern (4.1, 4.2) different effects (2.1, 2.2-2.4) can be combined sequentially together; forming an entity called pattern. The patterns have one free parameter: the pattern designation or name. The name enables to distinguish between different patterns (4.1, 4.2) and to separate one pattern from others. The patterns can be combined to form the root of a pattern (6) tree. The pattern tree may be extended by different intermediate stages toe sort e.g. different patterns of different applications.

Every pattern can be sorted under the RootOfPatterns (6) element. Furthermore, every effect (2.1-2.4) must be under some pattern (4.1, 4.2). A pattern containing no vibration effect produces no vibration when called.

FIG. 2 shows an example pattern that produces a vibration with the intensity of 60% and a duration of one second. Every XML-file must contain the <RootOfPatterns>-element. This element has a closing tag similar to HTML-tags. Every pattern and effect must be under these tags. The patterns are similar to RootOfPatterns-tag, but contain one parameter, i.e. name or designation of the pattern. A pattern is defined using the start tag <Pattern name=“Put the name of the pattern here”> and the end tag </Pattern>.

As mentioned above, an empty pattern effects no vibration. Effects were designed to implement the actual vibration. An effect tag has three parameters: the name, time/duration, and intensity. The tag is defined like this: <Effect name=“Effect name” intensity=“the intensity value of the range 0-100” time=“the time value from 0-to infinity” />. The effect tag is different from the others, because it doesn't have an ending tag </Effect>, it instead has a slash in the end />. The scale used here is a microsecond, i.e. 0,000001 second. The range of time parameter is from 0 to theoretically infinity. Here is an example: if one would like to have a second of vibration, the time would equal to 1000000.

The depicted effect tag is provided to implement a vibration with the intensity of 60% and a duration of one second by the expression <Effect name=“Long” intensity=“60” time=“1000000”>.

In FIG. 3, the example pattern of FIG. 1 is extended by a pause (i.e. intensity-0) of half a second and then a new and different effect with 60% intensity and a duration or a 1/100 second.

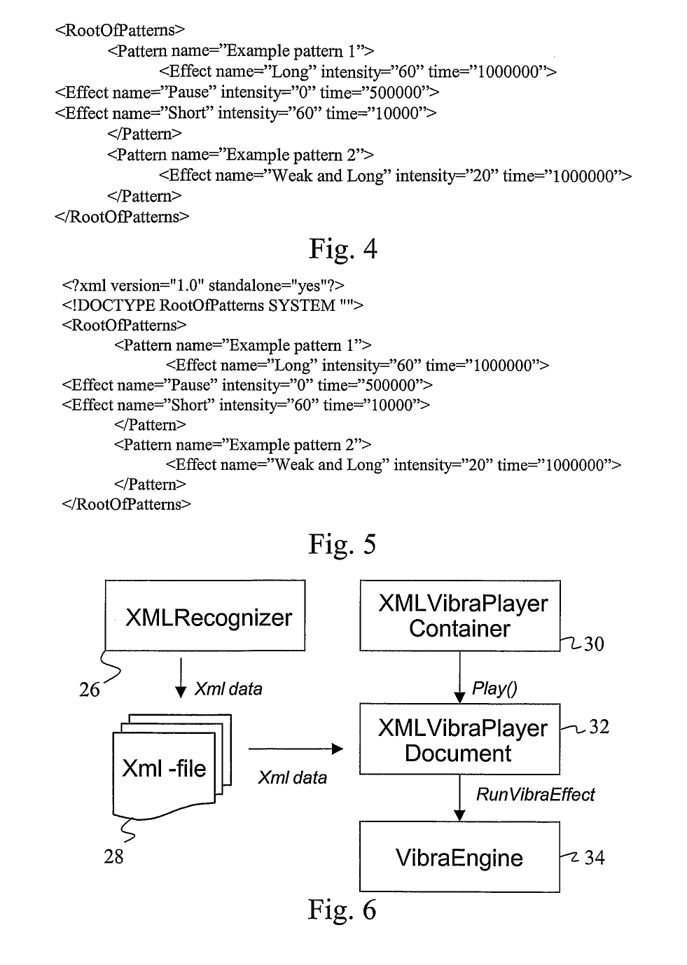

In FIG. 4, the example pattern FIG. 3 is combined with a second pattern in a pattern tree. That is more than one pattern can be defined under the RootOfPatterns tag. The second pattern is defined by a name “Example pattern 2”, and comprises a vibration effect with an intensity of 20% and a duration of 1 second.

FIG. 5 represents the whole XML code in an executable form. The code of FIG. 4 is extended by an XML-tag and a doctype-tag. Provided with these two tags, the present code is a valid and well-formed XML-file, which can be loaded to an actual phone. An XMLVibraPlayer-software is able to open this file and generate the patterns.

FIG. 6 depicts a possible implementation of a program architecture for reproducing vibrations from received XML coded files by other applications. The architecture comprises an XML-file recognizer to recognize incoming data as XML data. The recognizers have an ending “.mdl” and are located in the directory “\System\recogs”. The Architecture automatically detects and loads the recognizers. For executing the files the Operating System of the device checks every recognizer, finds the matching ones, and executes the files with the highest priorities.

For the reproduction of vibrations on mobile devices a recognizer called XMLRecognizer can be used for an XMLVibraPlayer-application. The XMLRecognizer can recognize files with the ending .xml and opens the XMLVibraPlayer-application with the file loaded into it.

The XMLRecognizer 26 identifies XMLfiles 28 with specific file endings and executes something. The XML Recognizers can be programmed to start programs 30, 32, 34 which are to be executed upon identification of an XML file 28. Here, the XMLVibraPlayer-application has its own recognizer called XMLRecognizer 26.

The XMLVibraPlayer consists of four classes. The most important ones are the XMLVibraPlayerDocument 32 and the XMLVibraPlayerContainer 30. XMLVibraPlayerDocument 32 is responsible for creating the on-screen pattern list, creating the XML tree and opening the XML file. The class also contains the Play( )-function which uses the function RunVibraEffect( ) of the VibraEngine. The XMLVibraPlayerContainer 30 handles the user input or the input from other application programs and draws everything on screen.

The VibraEngine 34 executes the commands RunVibraEffect and controls the operation of a connected vibration actuator (not shown). A received XML file can be stored on the terminal device to be reproduced later or may also be reproduced instantaneously. In the depicted architecture the XMLRecognizer 26 serves to recognize and store received XML files 28 with vibration patterns in the XMLVibraPlayerDocument 32.

The content of the XML files 28 stored can be accessed e.g. by a game application via a XMLVibraPlayerContainer 30 serving as an Application Program Interface. The application program interface XMLVibraPlayerContainer can request the different patterns to be reproduced by the command Play (pattern).

The requested pattern is then selected from the data in the XMLVibraPlayerDocument 32 and transferred to the VibraEngine to be reproduced by controlling a respective vibration actuator accordingly. The VibraEngine.dll. is a manufacturer-provided middleware component. The present invention requires no hash table or similar approach.

The designation parameter may be is mandatory for the XMLVibraPlayer application. Even the designation parameter may not be supported or implemented in the vibra control, as the middleware software module (vibraengine.dll) does not need to send it either downwards.

When the pattern is (with suitable effects) ready. It could be copy-pasted to applications, which will further use the middleware component providing access to vibra control. This middleware component does not necessarily need to have name parameter, since it does not provide any extra information in low level vibra control (i.e. the vibration actuator can play the vibra patterns/effects without knowing the designations).

This can reduce the efforts necessary to implement vibration effects, as the application program can access pre-stored vibration patterns on the terminal device. The application program only needs to issue a request for a certain vibration pattern.

FIG. 7 is a simplified block diagram illustrating an example of the structure of a mobile terminal device. The depicted device 40 comprises an interface 44, a central processing unit (CPU) 42, storage 48 and a vibration actuator 46. The device 40 can receive vibration patterns via said input interface 44, and store them in the storage 48. If an application running on said CPU 42 requests the reproduction of a vibration pattern the CPU 42 said can query said storage 46 for the requested vibration pattern. If said selected vibration pattern is found in said storage, the CPU 42 can control the vibration actuator 46, according to the vibration effects in of said requested pattern.

FIG. 8 illustrates the generation of a vibration pattern according to a basic implementation of the present invention. FIG. 8 comprises three time-synchronized diagrams each representing an intensity of a vibration. The diagram 12 represents a vibration to be implemented. The diagram 16 represents a representation of the vibration implemented according to the present invention as a pattern with different vibration effects. The diagram 20 represents a representation of the voltage supply to a vibration actuator to implement the vibration of the of diagram 16.

The diagram 12 represents a vibration to be implemented that is composed of the succession of a strong initial vibration 8.1, a pause 8.2, a medium vibration 8.3, a second pause 8.4, and an increasing vibration 8.5-8.7. The y-axis 10 of the diagram 12 represents intensity or amplitude of the vibration. The initial vibration may be based in a recorded vibration data, on an imaginative vibration pattern a programmer has in his mind.

The diagram 16 represents the of diagram 12 translated into a vibration pattern with different vibration effects 8.1 to 8.7. The y-axis 14 of the diagram 16 represents the intensity defined as a percentage of a vibration. The (partially) continuous vibration of diagram 12 is represented by a number of rectangular blocks, each representing a vibration effect. In the depicted scale the strong initial vibration 8.1 represented by a 100% vibration with the duration of 1000 μs, followed by the pause 8.2 with 0% intensity and a duration of 500 μs, the medium vibration 8.3 is represented by 50% intensity and a duration of 1500 μs. The second pause 8.4 is represented by 0% vibration and a duration of 100 μs, and an increasing vibration 8.5-8.7. is represented by three subsequent effects with 25%, 50%, and 75% vibration, and duration of 666 μs each.

A greater number of vibration effects can be used to better approach the increasing vibration 8.5-8.7. of diagram 12, but for the expense of an increased amount of data. The depicted three vibration effects represent a sufficient approach for visualizing the principle of the present invention. The diagram 16 represents a representation of a single vibration pattern composed of the vibration effects 8.1 to 8.7.

The diagram 20 represents the voltage signal provided to a vibration actuator according to one embodiment of the present invention. The y-axis 18 of the diagram 20 represents a voltage supplied to a vibration actuator. The voltage signal is pulse width modulated. The depicted voltage modulation is based on a modulation frequency of 10000 Hz. That is the duty cycle is switched one an off once every 100 μs. This duty cycle has been selected to be able to visualize the PWM signal. In the depicted scale the strong initial vibration 8.1 represented by a continuous power supply of the vibration actuator, followed by the pause 8.2 with no supplied voltage. The medium vibration 8.3 is represented by 50% duty cycle i.e. a voltage signal changing with a duration of 50 μs followed by a 50 μs zero volt signal for 1.5 ms. The second pause 8.4 is represented by a zero volt signal. The vibration effects 8.5-8.7. are represented by three subsequent signals with 25%, 50%, and 75% duty cycle. The clock frequency for the pulse width modulation (and the duty cycle) is not provided by the vibration pattern, nor by the vibration effects. The PWM frequency and the vibration frequency of the vibration actuator can be determined by device parameters.

Finally the disclosure of FIG. 8 may be summarized by providing a simple way to implement an program vibration outputs in devices by using a number of basic vibration elements of constant amplitude to assemble a vibration pattern out of a number of small fraction of a pattern called vibration effects. The patterns consist of one or more effects. Further, when describing the haptics events in XML format, both effect and pattern are provided with a name. For example the pattern of FIG. 8 may be designated “Game 34/collision1”, and the vibration effects may be designated First impact, pause dump over sidewalk), slide over ground and fall into ditch and stop.

This XML-file can be transferred e.g. by Bluetooth into a target device to do empiric testing with XMLVibraPlayer-application. The present invention provides a test tool to create appropriate effects for games in variety handsets. This is because the different handsets have different vibration motors. Effects created for one handset might not be felt same in other handsets.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. Method for implementing vibration output commands for controlling a vibration actuator of a mobile terminal device, comprising:
defining at least one vibration effect, defined by at least one vibration signal parameter,
defining at least one vibration pattern by at least one of said vibration effects, and
storing said at least one vibration pattern into a storage.

2. Method according to claim 1, wherein said vibration signal parameter includes at least one of a designation, an intensity, and a duration of a vibration.

3. Method according to claim 1, wherein said at least one vibration pattern is also defined by a designation of the vibration pattern.

4. Method according to claim 1, wherein said vibration patterns are further defined by a frequency and a phase of said vibration.

5. Method according to claim 1, further comprising:
retrieving said at least one stored vibration pattern, and
sending said at least one vibration pattern to a terminal device.

6. Method according to claim 1, further comprising
selecting at least one of said stored vibration patterns.

7. Method according to claim 1, further comprising:
receiving vibration data, and
defining said vibration effects and said at least one vibration pattern according to said vibration data.

8. Method for implementing vibration output commands for controlling a vibration actuator of a mobile terminal device, comprising:
receiving at least one vibration pattern, wherein each pattern is defined by a succession of vibration effects, wherein each vibration effect is defined by at least one vibration signal parameter, and
storing said at least one vibration pattern.

9. Method according to claim 8, further comprising:
receiving a request for a vibration pattern,
retrieving said requested vibration pattern, and
sequentially outputting each vibration effect, by controlling a vibration actuator accordingly.

10. Method for operating a vibration actuator of a mobile terminal device, comprising:
receiving at least one vibration pattern, wherein each pattern is defined by at least one vibration effect, and wherein each of said vibration effects is defined by at least one vibration signal parameter, and
sequentially outputting each of said at least one vibration effect of said received vibration pattern, by controlling a vibration actuator accordingly.

11. Method according to claim 10, wherein said vibration signal parameter includes at least one of a designation, an intensity, and a duration of a vibration.

12. Method according to claim 10, wherein said at least one vibration pattern is also defined by a designation of the vibration pattern.

13. (canceled)

14. (canceled)

15. Method according to claim 1, wherein said vibration intensity of said vibration effects is defined by a duty cycle.

16. Method according to claim 10, wherein said vibration patterns and vibration effects are stored and sent as extensible markup language coded data.

17. Software tool comprising program code means stored on a computer readable medium for carrying out the method of claim 1 when said software tool is run on a computer or network device.

18. Computer program product comprising program code stored on a computer readable medium for carrying out the method of claim 1 when said program product is run on a computer or network device.

19. Mobile terminal device comprising,
a processing unit,
an interface connected to said processing unit, and
a vibration actuator, connected to said processing unit,
wherein said terminal device is configured to receive at least one vibration pattern via said interface, wherein said vibration pattern comprises at least one vibration effect, and wherein each said vibration effect comprises at least one vibration signal parameter, and wherein said processing unit is further configured to control said vibration actuator according to said vibration signal parameters of said at least one vibration effect.

20. Mobile terminal device according to claim 19, wherein said vibration signal parameter includes at least one of a designation, an intensity, and a duration of a vibration.

21. Mobile terminal device according to claim 19, wherein said at least one vibration pattern is also defined by a designation of the vibration pattern.

22. Mobile terminal device according to claim 19, wherein said vibration patterns are received in form of extended markup language files.

23. Mobile terminal device according to claim 19, further comprising a storage to store said received vibration patterns.

24. Mobile terminal device according to claim 23, wherein said processing unit is configured to execute an application program capable of accessing stored vibration patterns.

25. Mobile terminal device according to claim 19, where in said interface comprises a radio interface.

26. Mobile terminal device according to claim 19, wherein said mobile terminal device comprises a mobile telephone, and wherein said vibration actuator is a vibration alarm actuator of the telephone.

27. Method according to claim 1, wherein said vibration intensity of said vibration effects is defined by a duty cycle.

28. Method according to claim 1, wherein said vibration patterns and vibration effects are stored and sent as extensible markup language coded data.

29. Method according to claim 8, wherein said vibration signal parameter includes at least one of a designation, an intensity, and a duration of a vibration.

30. Method according to claim 8, wherein said at least one vibration pattern is also defined by a designation of the vibration pattern.

31. Method according to claim 8, wherein said vibration intensity of said vibration effects is defined by a duty cycle.

32. Method according to claim 8, wherein said vibration patterns and vibration effects are stored and sent as extensible markup language coded data.

33. Method for implementing vibration output commands for controlling a vibration actuator of a mobile terminal device, comprising:
defining at least one vibration effect, defined by at least one vibration signal parameter,
defining at least one vibration pattern by a succession of said vibration effects, wherein each said vibration effect is defined by at least one vibration signal parameter, and
receiving said at least one vibration pattern, and storing said at least one vibration pattern into a storage.

34. Method for implementing vibration output commands for controlling a vibration actuator of a mobile terminal device, comprising:
defining at least one vibration effect, defined by at least one vibration signal parameter;
defining at least one vibration pattern by at least one of said vibration effects;
storing said at least one vibration pattern into a storage;
receiving the at least one vibration pattern; and
sequentially outputting each of said at least one vibration effect of said received vibration pattern, by controlling the vibration actuator accordingly.
